(19) United States
(12) Patent Application Publication
(10) Pub. No.: US 2026/0145200 A1
(43) Pub. Date: May 28, 2026

(54) ADHESIVE APPLYING DEVICE

(71) Applicant: POU CHEN CORPORATION, Chang Hwa Hsien (TW)

(72) Inventors: Ching-Hung CHEN, Taichung City (TW); Po-Jung CHEN, Xiushui Township (TW); Chien-Yu HSU, Chang Hwa Hsien (TW); Hsin-Chang SU, Taichung City (TW); Che-Ming YANG, Chang Hwa Hsien (TW)

(21) Appl. No.: 19/022,887

(22) Filed: Jan. 15, 2025

(30) Foreign Application Priority Data
Nov. 28, 2024 (TW) 113145970

(51) Int. Cl. B05C 11/02; B05C 5/02

(52) U.S. Cl. CPC B05C 11/023; B05C 5/027

(57) ABSTRACT

An adhesive applying device includes a base unit and a coating applicator disposed on the base unit. The base unit includes a base body having an outer side surface, and a blocker disposed on and projecting outwardly from the outer side surface. The blocker has a connecting portion connected to the base body, and a blocking portion extending outwardly from one side of the connecting portion that is opposite to the base body. The blocking portion has first and second side surfaces opposite to each other, and a blocking end surface connected between the first and second side surfaces and distal to the base body. The coating applicator includes a coating body disposed on and supported by the blocker and having a coating surface adjacent to the blocking end surface.

### CROSS-REFERENCE TO RELATED APPLICATION

This application claims priority to Taiwanese Invention Patent Application No. 113145970, filed on Nov. 28, 2024, and incorporated by reference herein in its entirety.

### FIELD

The present disclosure relates to an adhesive applying device, and more particularly to an adhesive applying device for applying adhesive to a shoe upper.

### BACKGROUND

FIG. 1 is a schematic view illustrating how a sole 7 is conventionally adhered to a shoe upper 8. The shoe upper 8 has a bottom surface 81, and a lower peripheral portion 82 connected to and surrounding the bottom surface 81. To adhere the sole 7 to the shoe upper 8, the shoe upper 8 is first sleeved on a last 80 with the bottom surface 81 thereof facing upward, after which the sole 7 is temporarily placed on the shoe upper 8, and a contour line 83 is drawn on the lower peripheral portion 82 of the shoe upper 8 along an edge of the sole 7. After the contour line 83 is drawn, the sole 7 is removed from the shoe upper 8. The contour line 83 and a periphery of the bottom surface 81 define therebetween a gluing area 821. A brush (not shown) is then used by an operator to apply adhesive (not shown) to the gluing area 821 along the contour line 83, after which the sole 7 is adhered to the shoe upper 8.

However, the above technique for applying the adhesive to the shoe upper 8 is prone to being unable to accurately control the movement of the brush along the contour line 83 due to insufficient skill of the operator, and it is difficult to control the coating range. This causes the adhesive to stain outside the gluing area 821 so that manual cleaning is required, and this leads to a decrease in production efficiency and yield.

### SUMMARY

Therefore, an object of the present disclosure is to provide an adhesive applying device that can alleviate at least one of the drawbacks of the prior art.

According to this disclosure, the adhesive applying device includes a base unit and a coating applicator disposed on the base unit. The base unit includes a base body having an outer side surface, and a blocker disposed on and projecting outwardly from the outer side surface of the base body along a first axial direction. The blocker has a connecting portion connected to the base body, and a blocking portion extending outwardly from one side of the connecting portion that is opposite to the base body. The blocking portion has a first side surface and a second side surface opposite to each other in a second axial direction transverse to the first axial direction, and a blocking end surface connected between the first and second side surfaces of the blocking portion and distal to the base body. The coating applicator includes a coating body disposed on and supported by the blocker and having a coating surface extending in the second axial direction and adjacent to the blocking end surface.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a schematic view illustrating how a sole is conventionally adhered to a shoe upper.

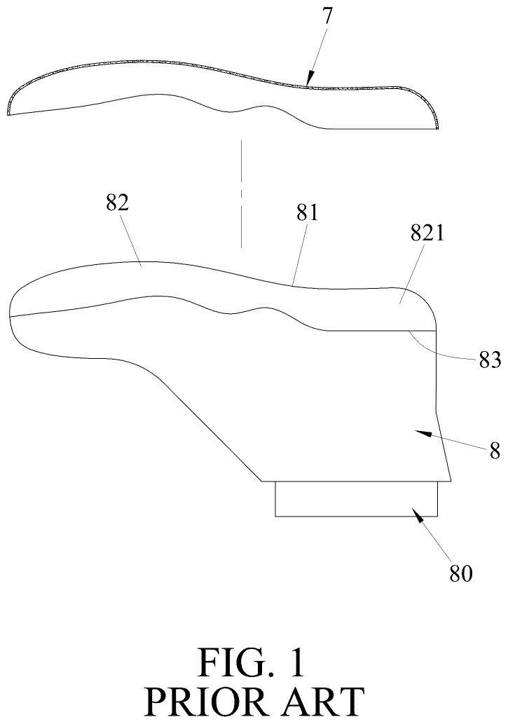

FIG. 2 is a fragmentary assembled perspective view of an adhesive applying device according to a first embodiment of the present disclosure and a driving device.

FIG. 3 is an exploded perspective view of a base unit and a coating applicator of the first embodiment.

FIG. 4 is a fragmentary sectional side view of the first embodiment.

FIG. 5 is a fragmentary sectional top view of the first embodiment.

FIG. 6 is a fragmentary schematic view illustrating a blocking portion of the first embodiment abutting against a contour line of a shoe upper, and the coating applicator applying adhesive to a gluing area of the shoe upper.

FIG. 7 is a fragmentary schematic view illustrating the blocking portion of the first embodiment abutting against another portion of the contour line of the shoe upper.

FIG. 8 is an assembled perspective view of a base unit and a coating applicator of an adhesive applying device according to a second embodiment of the present disclosure.

FIG. 9 is a perspective view of the base unit of the second embodiment.

FIG. 10 is a fragmentary sectional top view of the second embodiment.

FIG. 11 is a fragmentary sectional top view of an adhesive applying device according to a third embodiment of the present disclosure.

FIG. 12 is a fragmentary sectional top view of a base unit of an adhesive applying device according to a fourth embodiment of the present disclosure.

FIG. 13 is a fragmentary sectional top view of a base unit of an adhesive applying device according to a fifth embodiment of the present disclosure.

FIG. 14 is a fragmentary sectional top view of a base unit of an adhesive applying device according to a sixth embodiment of the present disclosure.

FIG. 15 is a fragmentary sectional top view of a base unit of an adhesive applying device according to a seventh embodiment of the present disclosure.

FIG. 16 is a fragmentary sectional top view of a base unit of an adhesive applying device according to an eighth embodiment of the present disclosure.

FIG. 17 is a fragmentary sectional top view of a base unit of an adhesive applying device according to a ninth embodiment of the present disclosure.

FIG. 18 is a perspective view of a base unit of an adhesive applying device according to a tenth embodiment of the present disclosure.

FIG. 19 is a perspective view of a base unit of an adhesive applying device according to an eleventh embodiment of the present disclosure.

FIG. 20 is a perspective view of a base unit of an adhesive applying device according to a twelfth embodiment of the of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

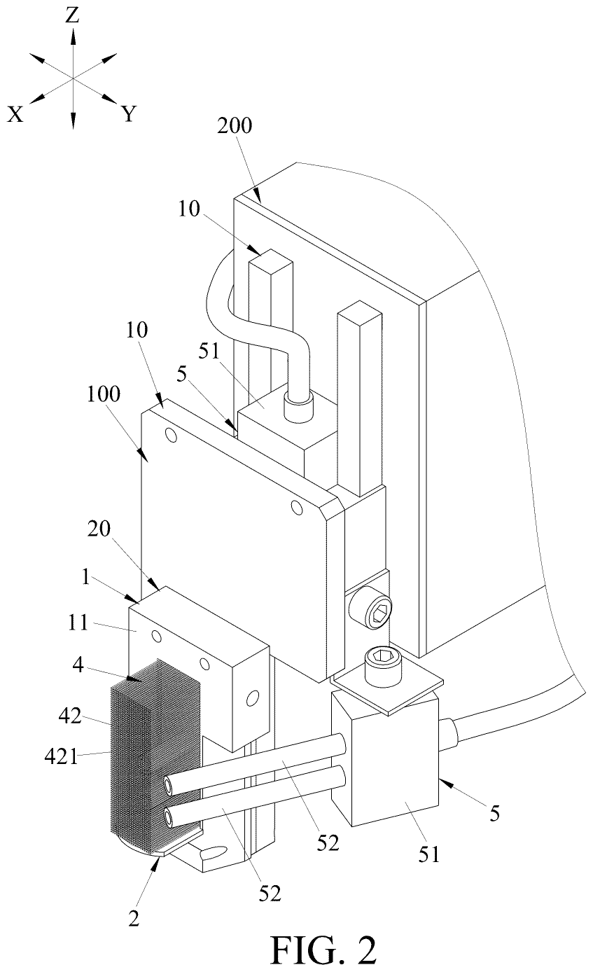

Referring to FIG. 2, an adhesive applying device 100 according to a first embodiment of the present disclosure is mounted on a driving device 200, and includes a support frame unit 10 disposed on the driving device 200, a base unit 20 disposed on the support frame unit 10, a coating applicator 4 disposed on the base unit 20, and two adhesive supply units 5 disposed on the support frame unit 10. The driving device 200 can drive the adhesive applying device 100 to move and rotate. Specifically speaking, the driving device 200 is a robotic arm. FIG. 2 only shows a part of the driving device 200.

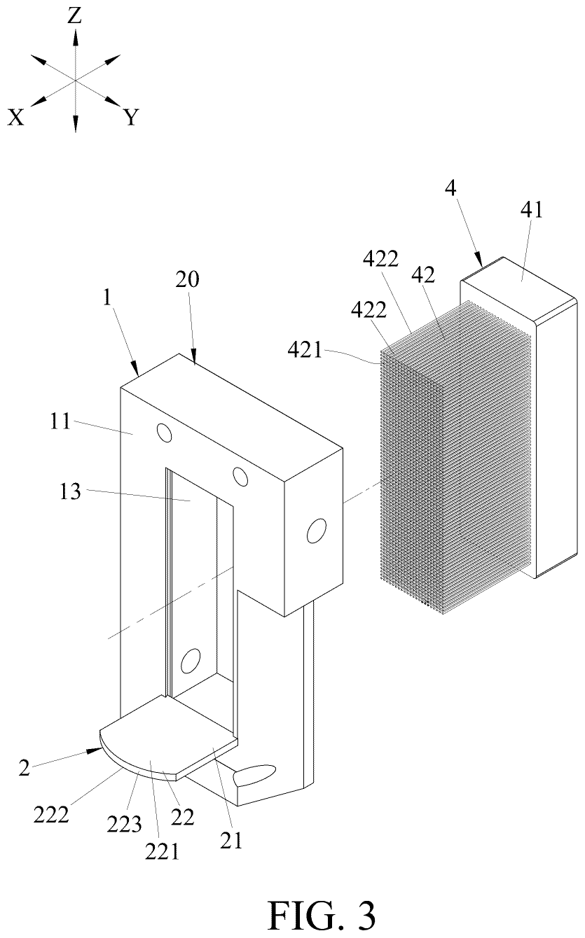

Referring to FIGS. 3 to 5, in combination with FIG. 2, the base unit 20 includes a base body 1 disposed on one side of the support frame unit 10 that is opposite to the driving device 200 along a first axial direction (X), and a blocker 2 disposed on the base body 1. The base body 1 has an outer side surface 11 opposite to the support frame unit 10 in the first axial direction (X), and an inner side surface 12 opposite to the outer side surface 11 and facing the support frame unit 10. The base body 1 extends along a second axial direction (Z) transverse to the first axial direction (X), and is formed with a mounting space 13 extending through the outer and inner side surfaces 11, 12 thereof. The mounting space 13 extends in the second axial direction (Z). Specifically, the base body 1 and the support frame unit 10 are fixed to each other by using a plurality of bolts (not shown) extending through the support frame unit 10 and threadedly engaging the base body 1. In this embodiment, the first axial direction (X) extends in a front-ear direction, the second axial direction (Z) extends in an up-down direction transverse to the first axial direction (X), and a third axial direction (Y) extends in a left-right direction transverse to the first and second axial directions (X, Z). It should be understood that the term“ transverse” recited in this embodiment refers to two or more directions that are nonparallel. Specifically, the first and second axial directions (X, Z) are perpendicular to each other.

The blocker 2 is disposed on and projects outwardly from the outer side surface 11 of the base body 1 in the first axial direction (X), and includes a connecting portion 21 connected to the outer side surface 11 of the base body 1 and adjacent to a lower side of the mounting space 13, and a blocking portion 22 extending integrally and outwardly from one side of the connecting portion 21 that is opposite to the base body 1. The blocking portion 22 has a first side surface 221 located on a top side thereof, a second side surface 222 opposite to the first side surface 221 in the second axial direction (Z), and a blocking end surface 223 connected between the first and second side surfaces 221, 222 and distal to the base body 1. Specifically, the blocking end surface 223 is parabolic.

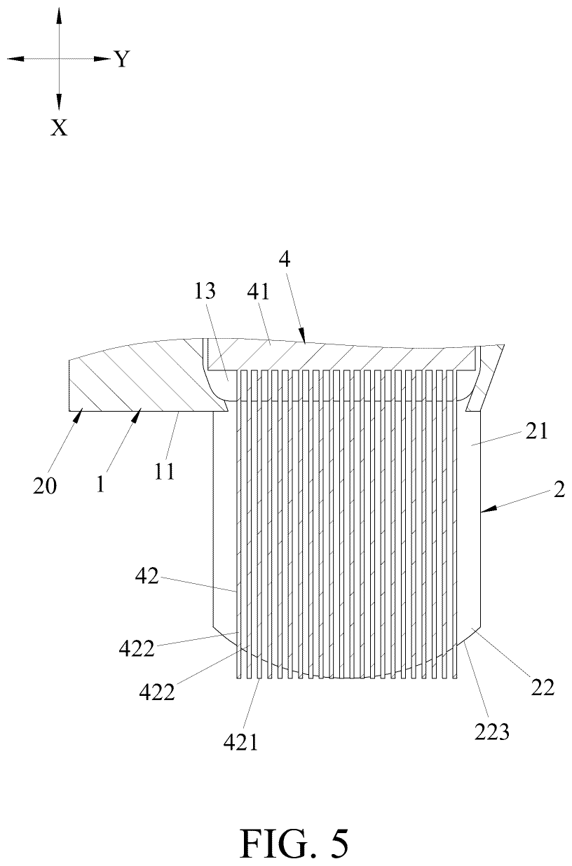

The coating applicator 4 is disposed on the base unit 20, and includes a mounting seat 41 received in the mounting space 13, and a coating body 42 connected to the mounting seat 41 and disposed on and supported by the blocker 2. The coating body 42 has a coating surface 421 adjacent to the blocking end surface 223 in the first axial direction (X). The coating surface 421 of this embodiment is a planar surface extending in the second axial direction (Z). As shown in FIG. 5, a central portion of the coating surface 421 is flush with the blocking end surface 223, while left and right end portions thereof extend beyond the blocking end surface 223. Specifically, in this embodiment, the coating body 42 is configured as a brush that includes a plurality of bristles 422 extending forwardly from the mounting seat 41 along the first axial direction (X). The tips of the bristles 422 that are located distal to the mounting seat 41 cooperatively define the coating surface 421 of the coating body 42. Although the coating body 42 is configured as a brush in this embodiment, in other variations of this embodiment, the coating body 42 may be a sponge, a cotton fabric, or other materials that can adhere or adsorb adhesive.

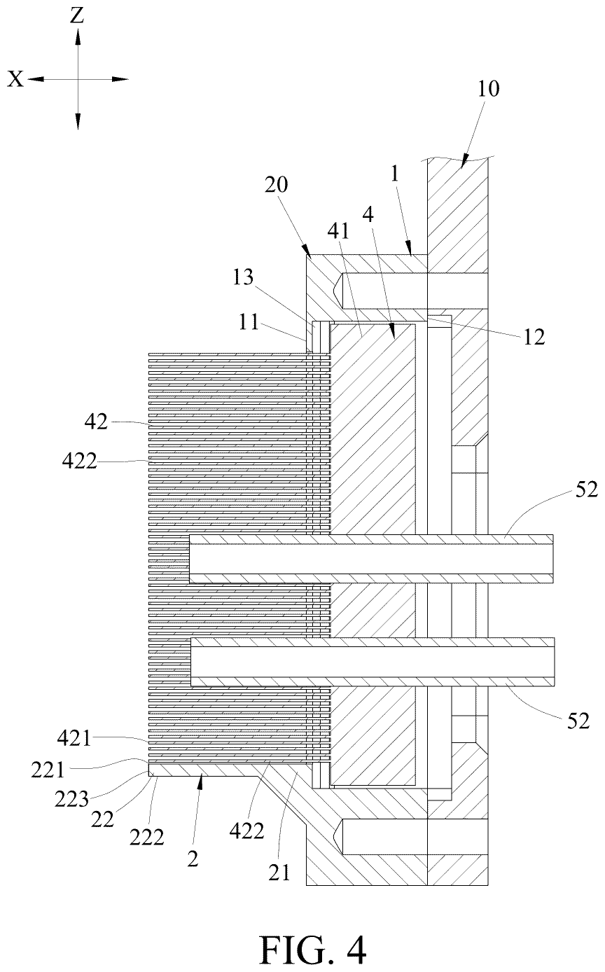

With reference to FIGS. 2 and 4, each adhesive supply unit 5 includes an adhesive supply device 51 disposed on the support frame unit 10 and connected to an adhesive source (not shown), and two adhesive supply tubes 52 connected to the adhesive supply device 51. The adhesive supply tubes 52 of one of the adhesive supply units 5 extend from a side of the base body 1 to a corresponding side of the coating body 42. The adhesive supply tubes 52 of the other adhesive supply unit 5 extend through the mounting seat 41 into the coating body 42, and are adjacent to the blocker 2.

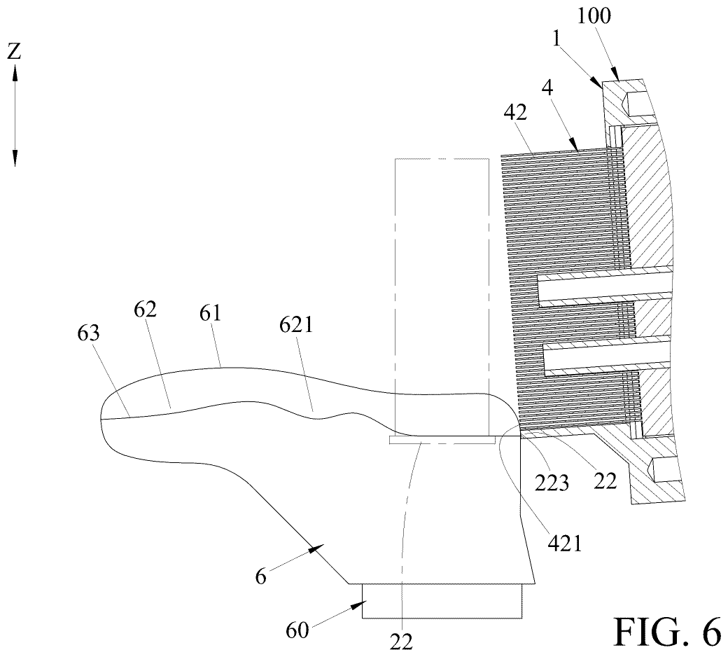

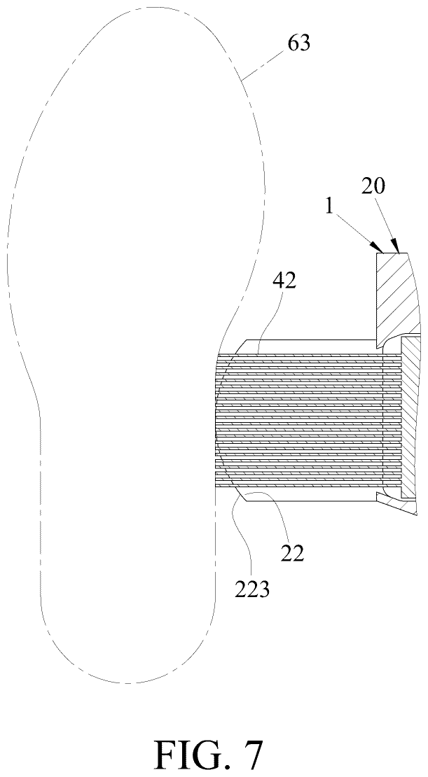

FIGS. 6 and 7 illustrate how the adhesive applying device 100 is driven to apply adhesive to a shoe upper 6. As shown in FIG. 6, the shoe upper 6 has a bottom surface 61, and a lower peripheral portion 62 connected to and surrounding the bottom surface 61. A contour line 63 is drawn on the lower peripheral portion 62 of the shoe upper 62 at a location adjacent to the bottom surface 61. The contour line 63 and a periphery of the bottom surface 61 define therebetween a gluing area 621. The method of drawing the contour line 63 is similar to that described in the Background of this application.

To apply adhesive to the shoe upper 6, the shoe upper 6 is first sleeved on a last 60 such that the bottom surface 61 thereof faces upwardly, after which the driving device 200 (see FIG. 2) is activated to drive the adhesive applying device 100 to move around the lower peripheral portion 62 of the shoe upper 6. During movement of the adhesive applying device 100, a portion of the blocking end surface 223 of the blocking portion 22 abuts against the contour line 63 of the shoe upper 6, and a lower end of the coating surface 421 abuts against the gluing area 621. Then, the blocking portion 22 is moved along the contour line 63 to apply the adhesive on the coating body 42 to the gluing area 621. Since the blocking end surface 223 is parabolic in shape, the blocking portion 22 can move smoothly according to a curvature of the contour line 63, as shown in FIG. 7, so as to uniformly apply the adhesive to the gluing area 621.

For adhesives with different viscosities, they will be conveyed through the different adhesive supply tubes 52. That is, adhesives with lower viscosities will be conveyed to the adhesive supply tubes 52 located in the coating body 42 for absorption by the coating body 42; while adhesives with higher viscosities will be conveyed to the coating body 42 through the adhesive supply tubes 52 that extend from the side of the base body 1 to the corresponding side of the coating body 42, after which the coating body 42 is used to uniformly apply the adhesives to the gluing area 621 of the shoe upper 6.

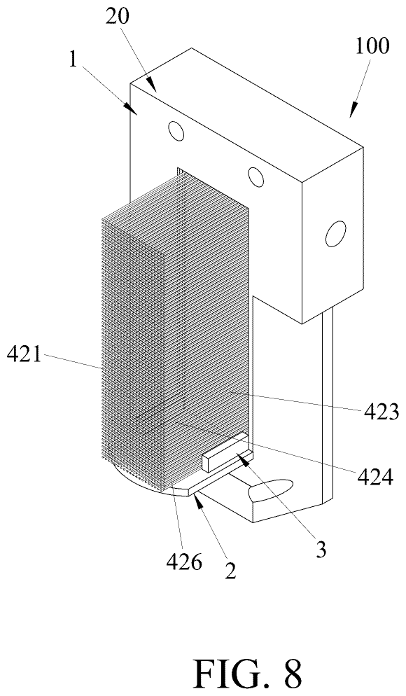

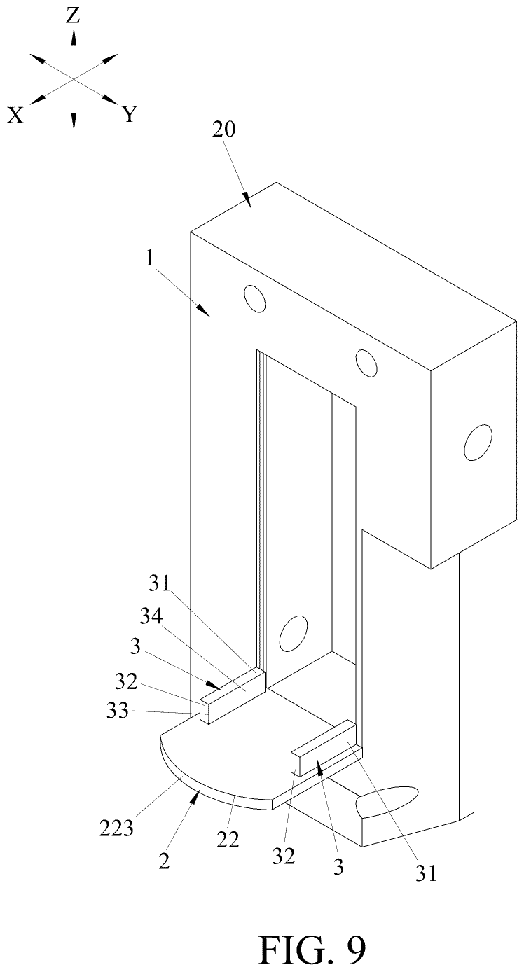

Referring to FIGS. 8 to 10, a second embodiment of the adhesive applying device 100 of this disclosure is substantially similar to the first embodiment, and differs from the first embodiment in that the base unit 20 further includes two limiting members 3 disposed on the blocker 2.

Specifically, the limiting members 3 are respectively connected to two sides of the blocker 2 that are opposite in the third axial direction (Y), and are respectively located on two sides of the coating body 42 that are opposite in the third axial direction (Y). The limiting members 3 extend from a position proximate to the base body 1 toward the blocking end surface 223 in the first axial direction (X). Each limiting member 3 has an inner end 31 proximate to the base body 1, and an outer end 32 opposite to the inner end 31 in the first axial direction (X) and adjacent to the blocking end surface 223. The outer ends 32 of the limiting members 3 cooperatively define an opening 33. Each limiting member 3 further has a clamping surface 34 facing the clamping surface 34 of the other limiting member 3. The clamping surfaces 34 of the limiting members 3 extend parallel to each other along the first axial direction (X) toward the opening 33.

A ratio of a width (W1) of the opening 33 in the third axial direction (Y) to a width (W2) of the blocking end surface 223 in the third axial direction (Y) ranges from 0.3 to 0.9. Specifically, in the second embodiment, the ratio of the width (W1) of the opening (33) in the third axial direction (Y) to the width (W2) of the blocking end surface 223 in the third axial direction (Y) is 0.74.

The coating body 42 includes a main body portion 423 connected to the mounting seat 41, and a coating end portion 424 connected to one side of the main body portion 423 that is opposite to the mounting seat 41 and having the coating surface 421. The main body portion 423 has a limiting section 425 located and clamped between the clamping surfaces 34 of the limiting members 3. The coating end portion 424 has a positioning section 426 connected to the limiting section 425 and protruding out of the opening 33 along the first axial direction (X).

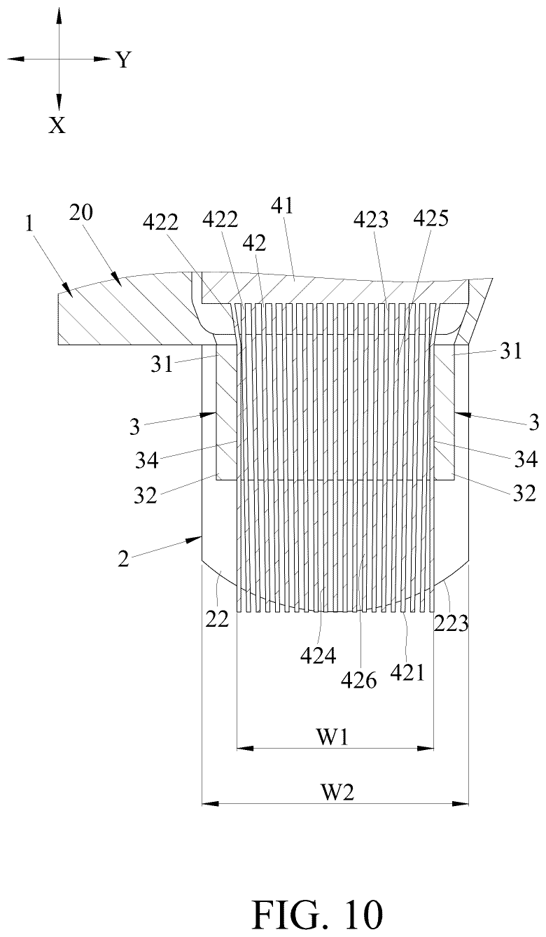

Referring back to FIG. 10, when the coating body 42 is moved around the lower peripheral portion 62 of the shoe upper 6 (see FIG. 6), the limiting section 425 is limited by the limiting members 3, so that the positioning section 426 is not easily offset from the blocker 2 due to force. Furthermore, the limiting section 425 is slightly squeezed by the clamping surfaces 34 of the limiting members 3 so as to drive the positioning section 426 to be concentrated, so that an area of the coating surface 421 located on the positioning section 426 is slightly reduced, thereby effectively limiting a coating range of the positioning section 426. Thus, when the blocking portion 22 moves to a curved portion of the contour line 63 (see FIG. 6), the probability of applying the adhesive beyond the contour line 63 can be further reduced.

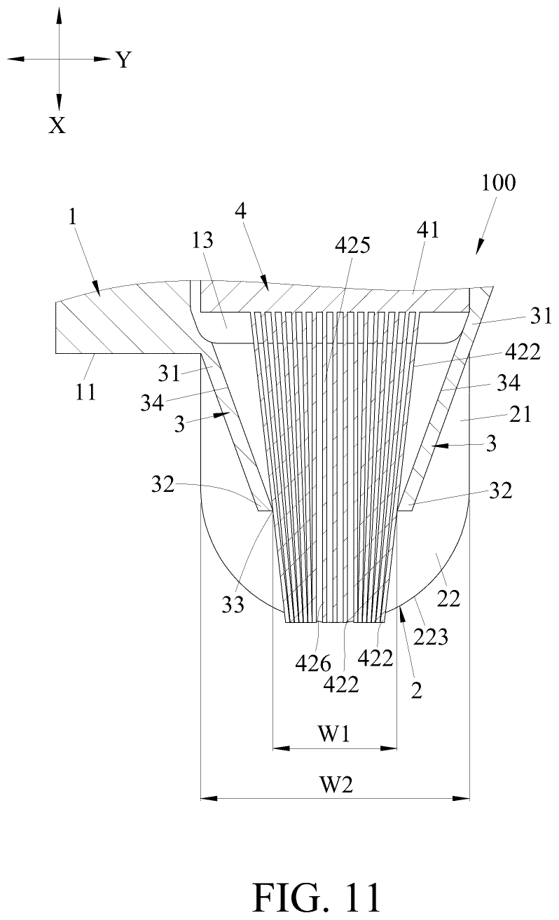

Referring to FIG. 11, a third embodiment of the adhesive applying device 100 of this disclosure is substantially similar to the second embodiment, and differs from the second embodiment in that the inner ends 31 of the limiting members 3 of the third embodiment are connected to the base body 1, and the limiting members 3 taper from the base body 1 toward the blocking end surface 223 such that the outer ends 32 thereof are close to each other, and the clamping surfaces 34 thereof gradually taper toward the opening 33. Furthermore, the ratio of the width (W1) of the opening 33 in the third axial direction (Y) to the width (W2) of the blocking end surface 223 in the third axial direction (Y) is 0.46. In other words, the width (W1) of the opening (33) in the third embodiment is smaller than that of the second embodiment. Therefore, the bristles 422 at the positioning section 426 are more concentrated, and are suitable to be applied to the shoe upper 6 with a large curvature change of the contour line 63, so that it is difficult for the adhesive to overflow out of the contour line 63.

Another difference between the third embodiment and the second embodiment resides in that the blocking end surface 223 of the blocker 2 of the third embodiment is arcuate in shape, and has a corner radius of 6.5 cm, and a width of the blocking end surface 223 in the third axial direction (Y) of this embodiment is smaller than that of the blocking end surface 223 in the third axial direction (Y) of the second embodiment. The blocker 2 of this embodiment is also suitable to be applied to the shoe upper 6 with a large curvature change of the contour line 63, and can move smoothly along the contour line 63.

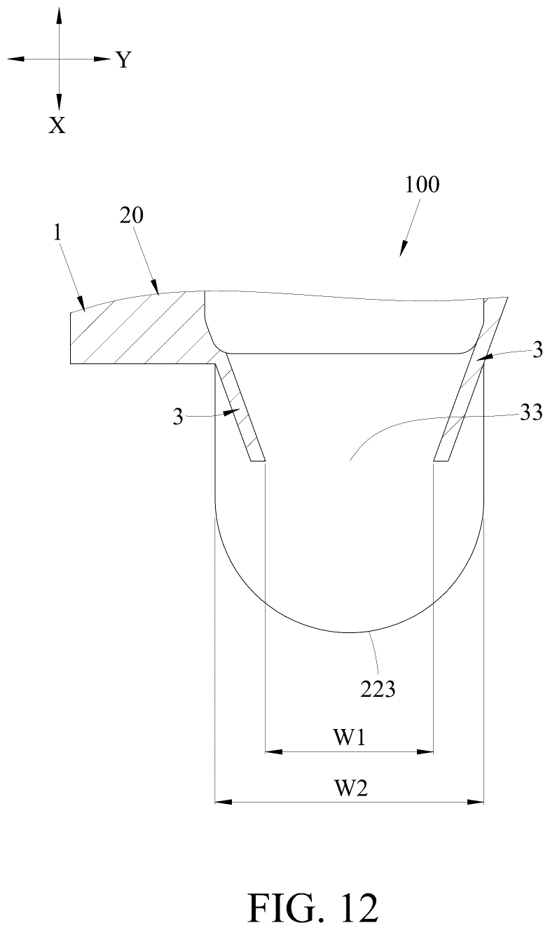

Referring to FIG. 12, a fourth embodiment of the adhesive applying device 100 of this is substantially similar to the third embodiment, and differs from the third embodiment in that, in the fourth embodiment, the ratio of the width (W1) of the opening (33) in the third axial direction (Y) to the width (W2) of the blocking end surface 223 in the third axial direction (Y) is 0.62, which is between the second and third embodiments. Thus, the coating range of this embodiment is also between the second and third embodiments.

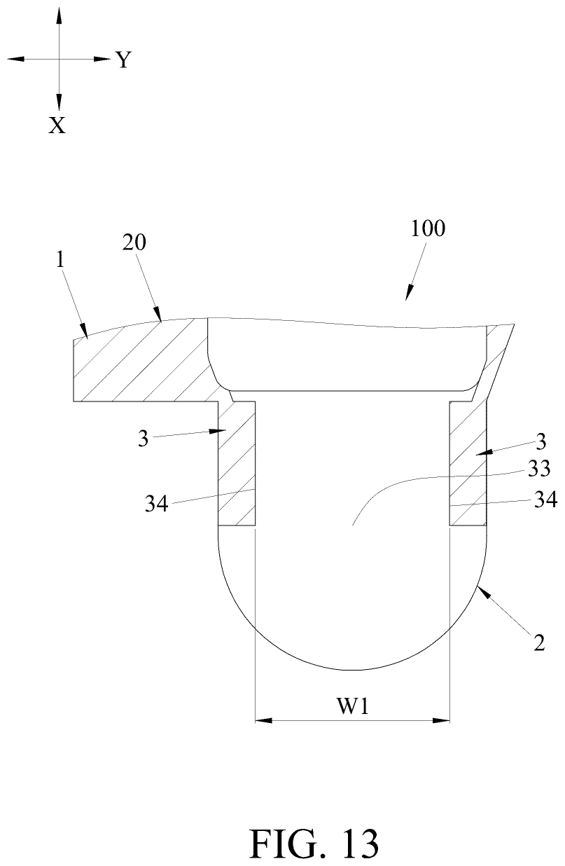

Referring to FIG. 13, a fifth embodiment of the adhesive applying device 100 of this disclosure is substantially similar to the third embodiment, and differs from the third embodiment in that the limiting members 3 are parallel to each other along the first axial direction (X), and each limiting member 3 has a thickness greater than that of each limiting member 3 in the third embodiment. Furthermore, the width (W1) of the opening 33 in the third axial direction (Y) is greater than that of the opening 33 in the third embodiment. Therefore, the coating range of this embodiment is greater than that of the third embodiment.

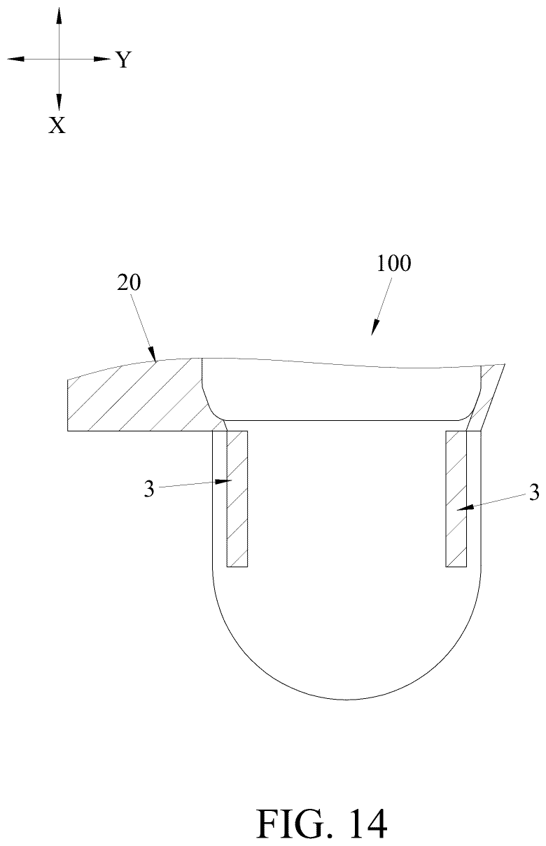

Referring to FIG. 14, a sixth embodiment of the adhesive applying device 100 of this disclosure is substantially similar to the fifth embodiment, but differs from the fifth embodiment in that the thickness of each limiting member 3 is smaller than that of each limiting member 3 in the fifth embodiment.

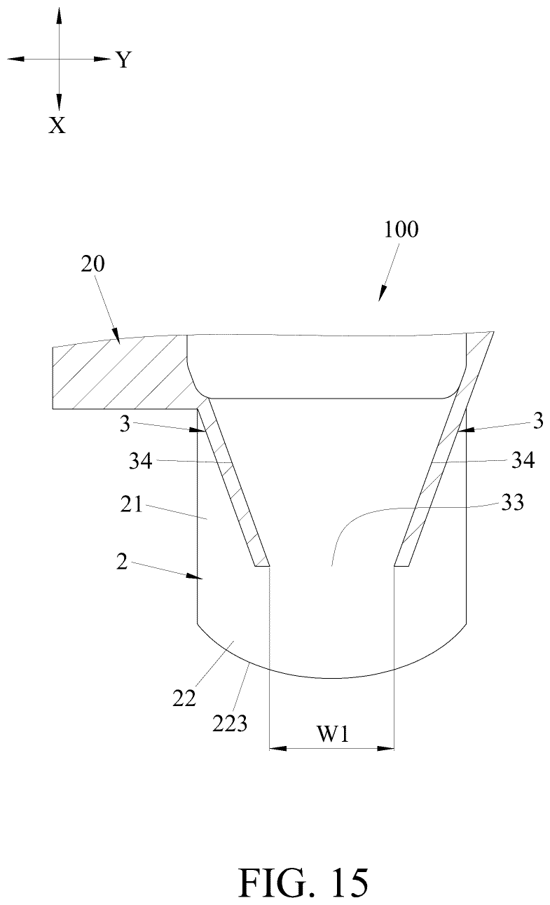

Referring to FIG. 15, a seventh embodiment of the adhesive applying device 100 of this disclosure is substantially similar to the second embodiment, and differs from the second embodiment in that the inner ends 31 of the limiting members 3 of the seventh embodiment are connected to the base body 1, and the limiting members 3 gradually taper from the base body 1 toward the blocking end surface 223 such that the outer ends 32 thereof are close to each other, and the clamping surfaces 34 thereof gradually taper toward the opening 33. Furthermore, the width (W1) of the opening 33 in the third axial direction (Y) of this embodiment is smaller than that of the opening 33 in the second embodiment, so that the coating range of this embodiment is smaller than that of the second embodiment.

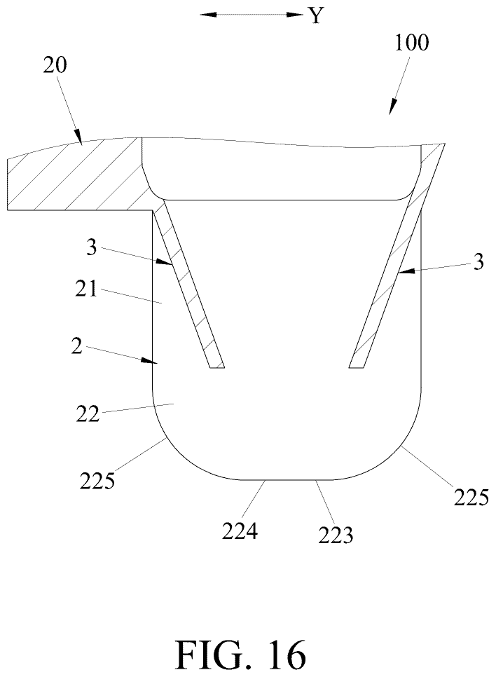

Referring to FIG. 16, an eighth embodiment of the adhesive applying device 100 of this disclosure is substantially similar to the third embodiment, and differs from the third embodiment in that the blocking end surface 223 of the blocking portion 22 of the eighth embodiment has a straight section 224 extending along the third axial direction (Y), and two arcuate sections 225 respectively connected to two opposite sides of the straight section 224. The corner radius of each arcuate section 225 is 4.5 cm. Hence, this embodiment is suitable to be applied to the shoe upper 6 with a small curvature change of the contour line 63 (see FIG. 7) in the second axial direction (Z).

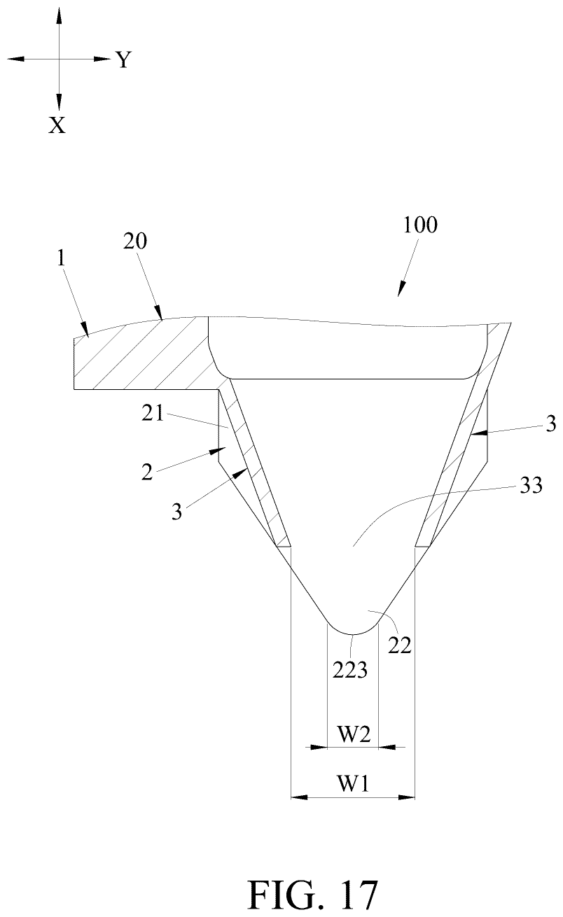

Referring to FIG. 17, a ninth embodiment of the adhesive applying device 100 of this disclosure is substantially similar to the third embodiment, and differs from the third embodiment in that the blocking portion 22 of the blocker 2 of the ninth embodiment has a substantially triangular shape that gradually tapers from the connecting portion 21 away from the base body 1. The blocking end surface 223 is located at one end of the blocking portion 22 that is distal to the base body 1, and has a curved shape. The corner radius of the blocking end surface 223 is 1.5 cm. The width (W1) of the opening 33 in the third axial direction (Y) is greater than the width (W2) of the blocking end surface 223 in the third axial direction (Y). Specifically, the ratio of the width (W1) of the opening 33 in the third axial direction (Y) to the width (W2) of the blocking end surface 223 in the third axial direction (Y) is 2.42. When the blocking end surface 223 abuts against the shoe upper 6, it has a large angle of rotation. Thus, compared with the third embodiment, the ninth embodiment is more suitable to be applied to the shoe upper 6 with a large curvature change of the contour line 63 in the second axial direction (z).

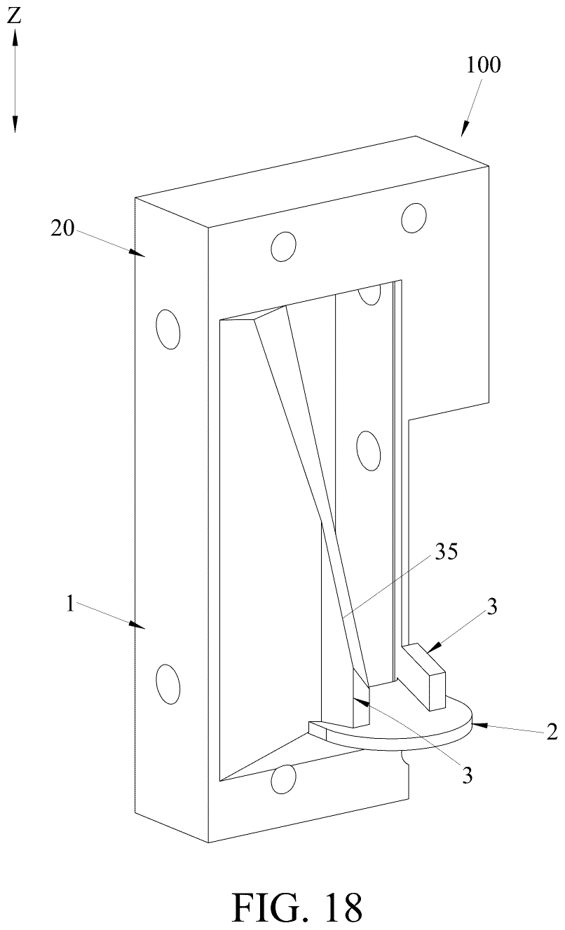

Referring to FIG. 18, a tenth embodiment of the adhesive applying device 100 of this disclosure is substantially similar to the third embodiment, and differs from the third embodiment in that the base unit 20 of the tenth embodiment further includes a reinforcing member 35 extending along the second axial direction (Z) and disposed between the base body 1 and one of the limiting members 3. As such, a connection strength between the base body 1 and the one of the limiting members 3 is high.

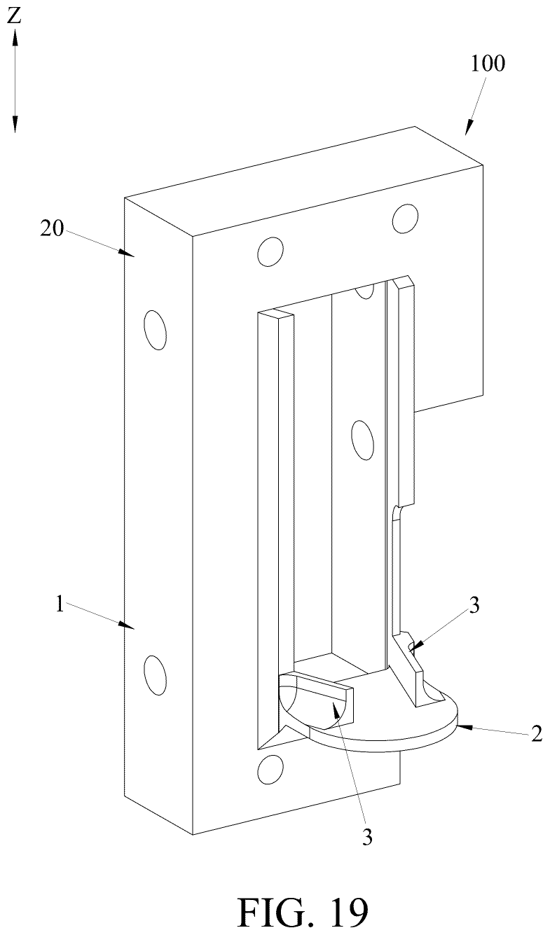

Referring to FIG. 19, an eleventh embodiment of the adhesive applying device 100 of this disclosure is substantially similar to the third embodiment, and differs from the third embodiment in that the thickness of each limiting member 3 gradually decreases upwardly from the blocker 2 in the second axial direction (Z). That is, a thickness at a junction of each limiting member 3 and the blocker 2 is thicker than a thickness of an end of each limiting member 3 that is distal to the blocker 2. As such, a connection strength among the base body 1, the blocker 2, and each limiting member 3 is high.

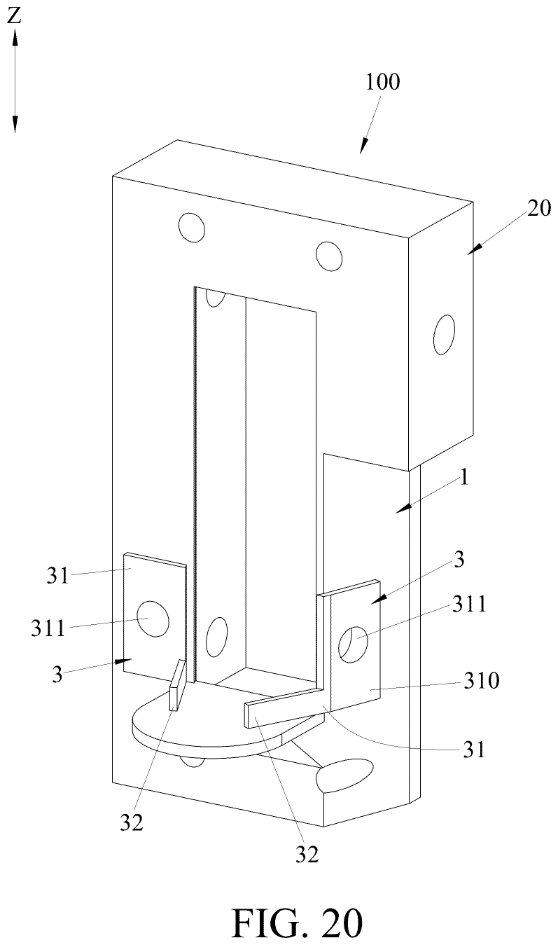

Referring to FIG. 20, a twelfth embodiment of the adhesive applying device 100 of this disclosure is substantially similar to the third embodiment, and differs from the third embodiment in that each limiting member 3 further has an extending portion 310 extending outwardly from the inner end 31 thereof and formed with a through hole 311. Two bolts (not shown) may be inserted through the through holes 311 in the extending portions 310 of the limiting members 3 to fix the limiting members 3 to the base body 1. In other words, each limiting member 3 of this embodiment can be detachably connected to the base body 1 through the extending portions 310 thereof. This can facilitate replacement of different types of the coating applicators 4 (see FIG. 11).

In summary, in the adhesive applying device 100 of this disclosure, with the blocking portion 22 of the blocker 2 abutting against the contour line 63 of the shoe upper 6, the position of the coating surface 421 of the coating applicator 4 can be accurately fixed, so that the blocking portion 22 can move stably along the contour line 63, thereby preventing applying the adhesive outside the gluing area 621, and thereby avoiding spending additional manpower and time to clean the adhesive outside the gluing area 621. Through this, the quality of adhesive coating and the production efficiency can be improved. Therefore, the object of this disclosure can indeed be achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An adhesive applying device comprising:
a base unit including a base body having an outer side surface, and a blocker disposed on and projecting outwardly from said outer side surface of said base body along a first axial direction, said blocker having a connecting portion connected to said base body, and a blocking portion extending outwardly from one side of said connecting portion that is opposite to said base body, said blocking portion having a first side surface, a second side surface opposite to said first side surface in a second axial direction transverse to the first axial direction, and a blocking end surface connected between said first side surface and said second side surface of said blocking portion and distal to said base body; and
a coating applicator disposed on said base unit and including a coating body disposed on and supported by said blocker, said coating body having a coating surface extending in the second axial direction and adjacent to said blocking end surface.

2. The adhesive applying device as claimed in claim 1, wherein said base unit further includes two limiting members respectively connected to two sides of said blocker that are opposite in a third axial direction transverse to the first axial direction and the second axial direction and respectively located on two sides of said coating body that are opposite in the third axial direction, said limiting members cooperatively defining an opening, said coating body including a main body portion, and a coating end portion connected to said main body portion and having said coating surface, said main body portion having a limiting section disposed between said limiting members, said coating end portion having a positioning section connected to said limiting section and protruding out of said opening.

3. The adhesive applying device as claimed in claim 2, wherein a ratio of a width of said opening in the third axial direction to a width of said blocking end surface in the third axial direction ranges from 0.3 to 0.9.

4. The adhesive applying device as claimed in claim 2, wherein said limiting members extend from a position proximate to said base body toward said blocking end surface, each of said limiting members having an inner end proximate to said base body, and an outer end opposite to said inner end in the first axial direction and adjacent to said blocking end surface, said outer ends of said limiting members cooperatively defining said opening, each of said limiting members further having a clamping surface facing said clamping surface of the other one of said limiting members, said clamping surfaces of said limiting members extending parallel to each other toward said opening and clamping therebetween said limiting section of said main body portion.

5. The adhesive applying device as claimed in claim 2, wherein each of said limiting members has an inner end connected to said base body, and an outer end opposite to said inner end in the first axial direction and adjacent to said blocking end surface, said outer ends of said limiting members cooperatively defining said opening, each of said limiting members further having a clamping surface facing said clamping surface of the other one of said limiting members, said limiting members tapering from said base body toward said blocking end surface such that said outer ends of said limiting members are close to each other, and said clamping surfaces of said limiting members gradually taper toward said opening.

6. The adhesive applying device as claimed in claim 5, wherein each of said limiting members further has an extending portion extending outwardly from said inner end and detachably connected to said base body.

7. The adhesive applying device as claimed in claim 5, wherein said blocking portion of said blocker gradually tapers from said connecting portion away from said base body in the first axial direction, said blocking end surface of said blocking portion being located at one end of said blocking portion that is distal to said base body, and having a curved shape, a width of said opening in the third axial direction being greater than a width of said blocking end surface in the third axial direction.

8. The adhesive applying device as claimed in claim 1, wherein said blocking end surface of said blocking portion is parabolic in shape.

9. The adhesive applying device as claimed in claim 1, wherein said blocking end surface of said blocking portion is arcuate in shape.

10. The adhesive applying device as claimed in claim 1, wherein said blocking end surface of said blocking portion has a straight section extending along a third axial direction transverse to the first axial direction and the second axial direction, and two arcuate sections respectively connected to two opposite sides of said straight section.
